(19) United States
(12) Patent Application Publication
(10) Pub. No.: US 2026/0301561 A1
(43) Pub. Date: Oct. 1, 2026

(54) EXTRINSIC SENSOR CALIBRATION PATHWAY FOR AUTONOMOUS VEHICLE HUBS

(71) Applicant: Torc Robotics, Inc., Blacksburg, VA (US)

(72) Inventors: William Davis, Blacksburg, VA (US); Akshay Pai Raikar, Blacksburg, VA (US); Saurabh Bagalkar, Blacksburg, VA (US); Joseph R. Fox-Rabinovitz, Blacksburg, VA (US)

(21) Appl. No.: 18/583,576

(22) Filed: Feb. 21, 2024

(51) Int. Cl. G08G 1/01; H04W 4/38

(52) U.S. Cl. CPC G08G 1/01; H04W 4/38

(57) ABSTRACT

A vehicle hub includes an entry from a roadway, an exit, a calibration path connecting the entry to the exit, and a calibration marker positioned along the calibration path, where the calibration marker corresponds to at least one of a known road condition or calibration equipment, and where the at least one known position or calibration equipment is used to automatically calibrate an onboard sensor of an autonomous or semi-autonomous vehicle traveling along the calibration path. A vehicle includes a sensor, a memory storing instructions, at least one processor to receive signals from the sensor, access the memory, and execute the instructions to: travel along the calibration path of the vehicle hub, and automatically calibrate the sensor using at least one of the known road condition or calibration equipment.

### TECHNICAL FIELD

The field of the disclosure relates generally to vehicle control systems, and more specifically, to sensor calibration in a vehicle.

### BACKGROUND

The use of autonomous and semi-autonomous vehicles has become increasingly prevalent in recent years as their numerous potential benefits are realized. Calibration of the sensors and other receivers whose inputs are used to navigate and steer is critical to safe and effective operation. For instance, an inertial navigation system of a vehicle may rely on light detection and ranging (LiDAR), radio detection and ranging (radar), and satellite navigational communications to computationally visualize its position and surroundings. Human technicians may use external equipment to manually perform a checklist of different sensors as part of regular maintenance. After a period of nonuse, sensors may be realigned to reference frames before hitting the road. External calibration processes involve periods of standstill for some sensors, while others, such as inertial measurement units (IMUs), require vehicle movement while calibrating. Such processes can be labor and time intensive.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a vehicle hub includes an entry from a roadway, an exit, a calibration path connecting the entry to the exit, and a calibration marker positioned along the calibration path, where the calibration marker corresponds to at least one of a known road condition or calibration equipment, and where the at least one known position or calibration equipment is used to automatically calibrate an onboard sensor of an autonomous or semi-autonomous vehicle traveling along the calibration path.

According to another aspect, a vehicle includes a sensor, a memory storing instructions, at least one processor to receive signals from the sensor, access the memory, and execute the instructions to: travel along a calibration path of a vehicle hub, where a calibration marker is positioned along the calibration path, and where the calibration marker corresponds to at least one of a known road condition or positioned calibration equipment, and automatically calibrate the sensor using at least one of the known road condition or calibration equipment.

According to another aspect, a method of calibrating a sensor of a vehicle includes traveling along a calibration path of a vehicle hub, where a calibration marker is positioned along the calibration path, and where the calibration marker corresponds to at least one of a known road condition or positioned calibration equipment, digitally registering the marker, and automatically calibrating the sensor using at least one of the known road condition or calibration equipment.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 illustrates a vehicle that may include a truck that may further be conventionally connected to a single or tandem trailer to transport the trailers (not shown) to a desired location.

FIG. 2 is an exemplary schematic block diagram of a processing system for implementation of embodiments of the present disclosure.

FIG. 3 is a block diagram of an autonomous driving system, including an autonomous vehicle that is communicatively coupled with a mission control computing system.

FIG. 4 is a block diagram showing illustrative components of a sensor calibration system on a vehicle.

FIG. 5 is topographical diagram of an embodiment of an autonomous vehicle hub that includes external sensor calibration equipment strategically positioned along a designated calibration path.

FIG. 6 is topographical diagram of another embodiment of an autonomous vehicle hub that includes external sensor calibration equipment strategically positioned along a designated calibration path.

FIG. 7 is a flow diagram of an embodiment of a method of calibrating a sensor of a vehicle while traveling along a calibration path of a vehicle hub.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

An implementation includes a designated roadway and traffic pattern within an autonomous hub that enables automated calibration. The calibration path may minimize disruption to normal traffic and avoid decreasing hub throughput. The physical components and features using in the calibration may be strategically placed within the hub environment. Such components and features may include visual calibration targets, electronic signal exchanges, turns, inclines, and road curvatures, among others. The road may be laid out in a manner within the autonomous hub such that the calibration is performed in an efficient and automated manner.

The entry point to the hub of an embodiment may be oriented such that a vehicle enters by making a righthand turn. The exit from the hub in such a configuration may be oriented such that the vehicle makes a lefthand turn to leave the hub. In another implementation, the vehicle may enter using a lefthand turn and exit using a righthand turn. The reverse configuration of the entrance and exit to the hub may facilitate traffic flow.

In between the entrance and exit, the vehicle may follow a path around the main hub that contains a series of turns. Some of these turns may be banked with a known bank angle. The path may be surrounded at some locations with a series of targets, called a target jungle. A target jungle may be used to align optical sensors, such as cameras, LiDAR, and radar, among others, to each other. By the time the vehicle exits to the highway, it may have enough data for a robust initial extrinsic sensor calibration.

Static IMU calibrations may be performed while the vehicle is stopped at a target jungle(s). Such calibrations may include acceleration leveling and gyroscope biasing. To this end, an embodiment of the path may be designed with curves that cause the vehicle to eventually be facing 180 degrees relative to its orientation in a prior position along the path. In one example, the static portions of an IMU calibration may be performed at these points along the route, which may be marked with appropriate signage. Alternatively, the static IMU calibration may be performed with a simple maneuver before entering the path or with a rotating turntable.

An autonomous or semi-autonomous vehicle of an implementation may drive itself the around the calibration route by accessing stored and/or downloaded driving instructions. Another or the same embodiment may include visual cues that are recognized by the vehicle and guide it throughout the hub. In another example, the vehicle may be guided by a shepherd vehicle partially or throughout the path and hub. Such a configuration may reduce memory requirements for vehicle by avoiding storage of the route in vehicle memory.

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, or steering, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA. The semi-autonomous vehicle requires a human driver at all times for operating the semi-autonomous vehicle.

A non-autonomous vehicle: A non-autonomous vehicle is a vehicle that is driven by a human driver. A non-autonomous vehicle is neither an autonomous vehicle nor a semi-autonomous vehicle. A non-autonomous vehicle has an autonomy level of level-0 recognized by NHTSA.

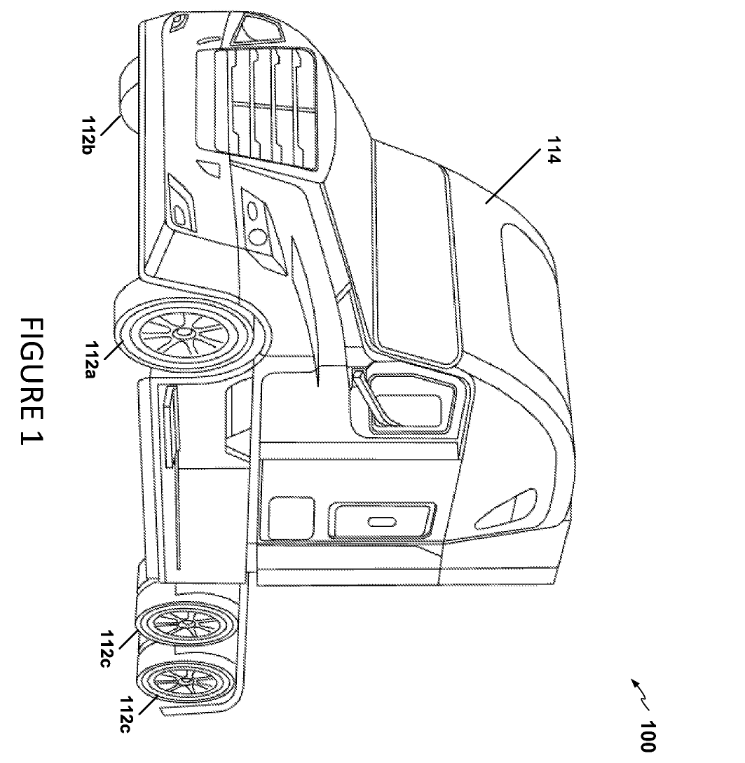

FIG. 1 illustrates a vehicle 100 that may include a truck that may further be conventionally connected to a single or tandem trailer to transport the trailers (not shown) to a desired location. The vehicle 100 includes a cab 114 that can be supported by, and steered in, the required direction by front wheels 112a, 112b, and rear wheels 112c that are partially shown in FIG. 1. Wheels 112a, 112b are positioned by a steering system that includes a steering wheel and a steering column (not shown in FIG. 1). The steering wheel and the steering column may be located in the interior of cab 114. The steering wheel and the steering column, and all or parts of cab 114 may be omitted in an autonomous vehicle.

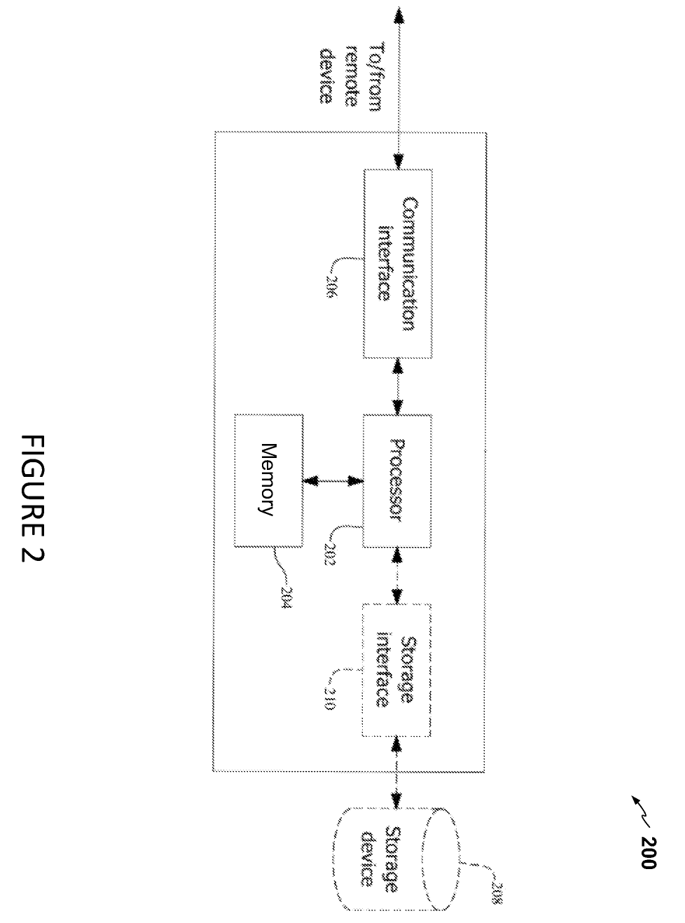

FIG. 2 is an exemplary schematic block diagram of a processing system 200 for implementation of embodiments of the present disclosure. The processing system 200 may include the hub calibration system described herein. The processing system 200 may include one or more processing units or processors 202 (e.g.,in a multi-core configuration). Processor 202 may be operatively coupled to a communication interface 206 such that the processing system 200 is capable of communicating with another device, such as a remote application server, a user equipment, a mobile device, a smart vehicle, a mission control or a central hub, or another processing system, for example, using wireless communication or data transmission over one or more radio links or digital communication channels using one or more of a Wi-Fi protocol, an RFID protocol, or a Near-Field Communication (NFC) protocol, as one-way communication or two-way communication.

Processor 202 may also be operatively coupled to a storage device 208. Storage device 208 may be any computer-operated hardware suitable for storing or retrieving data, such as, but not limited to, data associated with historic databases. In some embodiments, storage device 208 may be integrated in the processing system 200. For example, the processing system 200 may include one or more hard disk drives as storage device 208.

In other embodiments, storage device 208 may be external to the processing system 200 and may be accessed by a using a storage interface 210. For example, storage device 208 may include a storage area network (SAN), a network attached storage (NAS) system, or multiple storage units such as hard disks or solid-state disks in a redundant array of inexpensive disks (RAID) configuration.

In some embodiments, processor 202 may be operatively coupled to storage device 208 via the storage interface 210. Storage interface 210 may be any component capable of providing processor 202 with access to storage device 208. Storage interface 210 may include, for example, an Advanced Technology Attachment (ATA) adapter, a Serial ATA (SATA) adapter, a Small Computer System Interface (SCSI) adapter, a RAID controller, a SAN adapter, a network adapter, or any component providing processor 202 with access to storage device 208.

The processor 202 may execute computer-executable instructions for implementing aspects of the disclosure. In some embodiments, the processor 202 may be transformed into a special purpose microprocessor by executing computer-executable instructions or by otherwise being programmed. In some embodiments, and by way of a non-limiting example, the memory 204 may include instructions to perform specific operations, as described herein.

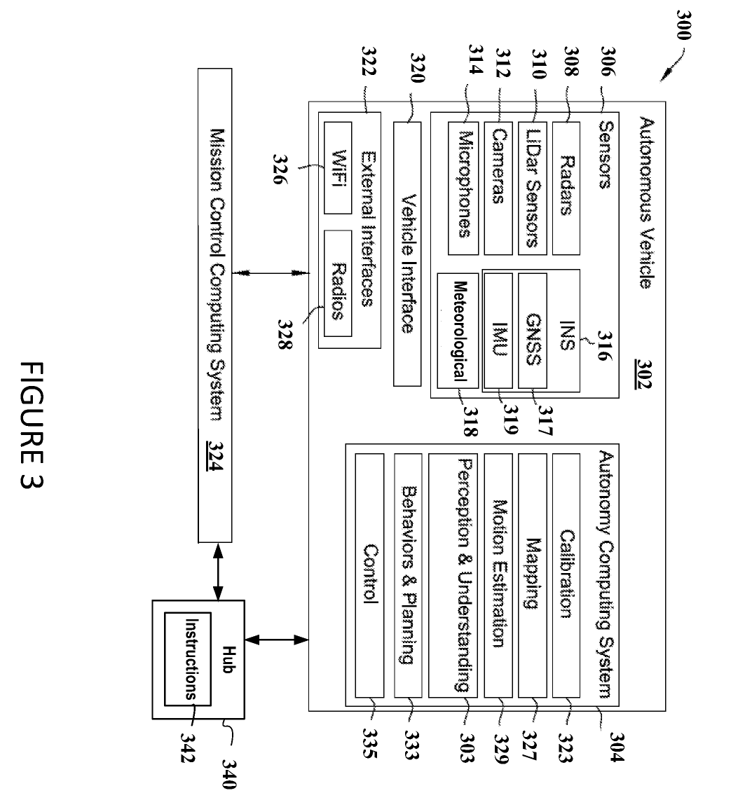

FIG. 3 is a block diagram of an autonomous driving system 300, including an autonomous vehicle 302 that is communicatively coupled with a mission control computing system 324. The vehicle 302 may be similar or the same as described with reference to any of the preceding figures.

In some embodiments, the mission control computing system 324 may transmit control commands or data to the autonomous vehicle 302, navigation commands, and travel trajectories to the autonomous vehicle 302, and may receive telematics data from the autonomous vehicle 302. When in a hub 340 the vehicle may communicate with the hub 340 and receive instructions 342 to facilitate sensor calibration.

In some embodiments, the autonomous vehicle 302may further include sensors 306. Sensors 306 may include RADAR devices 308, light detection and ranging (LiDAR) sensors 310, cameras 312, and acoustic sensors 314. The sensors 306 may further include an inertial navigation system (INS) 316 configured to determine states such as the location, orientation, and velocity of the autonomous vehicle 100. The INS 316 may include at least one global navigation satellite system (GNSS) receiver 317 configured to provide positioning, navigation, and timing using satellites. The INS 316 may also include at least one inertial measurement unit (IMU) 319 configured to measure motion properties such as the angular velocity, linear acceleration, or orientation of the autonomous vehicle 100. The meteorological sensors 318 are used to acquire meteorological data, such as the humidity, atmospheric pressure, wind, or precipitation, of the ambient environment of autonomous vehicle 302.

The autonomous vehicle 302 may further include a vehicle interface 320, which interfaces with an engine control unit (ECU) (not shown) or a MCU (not shown) of the autonomous vehicle 302 to control the operation of the autonomous vehicle 302 such as acceleration and steering.

The autonomous vehicle 302 may further include external interfaces 322 configured to communicate with external devices or systems such as another vehicle or mission control computing system 324. The external interfaces 322 may include Wi-Fi 326, other radios 328 such as Bluetooth, or other suitable wired or wireless transceivers such as cellular communication devices. Data detected by the sensors 306 may be transmitted to mission control computing system 324 via any of the external interfaces 322.

The autonomous vehicle 302 may further include an autonomy computing system 304. The autonomy computing system 304 may control driving of the autonomous vehicle 100 through the vehicle interface 320. The autonomy computing system 304 may operate the autonomous vehicle 302 to drive the autonomous vehicle from one location to another.

In some embodiments, the autonomy computing system 304 may include modules for performing various functions. Modules 323 may include a calibration module 323, a mapping module 327, a motion estimation module 329, perception and understanding module 303, behaviors and planning module 333, and a control module 335. The modules and submodules may be implemented in dedicated hardware such as, for example, an application specific integrated circuit (ASIC), field programmable gate array (FPGA), or microprocessor, or implemented as executable software modules, or firmware, written to memory and executed on one or more processors onboard the autonomous vehicle 302.

In some embodiments, based on the data collected from the sensors 306, the autonomy computing system 304 and, more specifically, perception and understanding module 303 senses the environment surrounding the autonomous vehicle 302 by gathering and interpreting sensor data. A perception and understanding module 303 interprets the sensed environment by identifying and classifying objects or groups of objects in the environment. For example, perception and understanding module 303 in combination with various sensors 306 (e.g., LiDAR, camera, radar, etc.) of the autonomous vehicle 100 may identify one or more objects (e.g., pedestrians, vehicles, debris, etc.) and features of a roadway (e.g., lane lines) around autonomous vehicle 302, and classify the objects in the road distinctly.

In some embodiments, a method of controlling an autonomous vehicle, such as autonomous vehicle 302, includes collecting perception data representing a perceived environment of autonomous vehicle 302 using the perception and understanding module 303, comparing the perception data collected with digital map data, and modifying operation of the vehicle 302 based on an amount of difference between the perception data and the digital map data. Perception data may include sensor data from sensors 306, such as cameras 312, LiDAR sensors 310, RADAR 308, or from other components such as motion estimation 329 and mapping 327.

The mapping module 327 receives perception data or raw sensor data that can be compared to one or more digital maps stored in mapping module 327 to determine where the autonomous vehicle 302 is in the world or where autonomous vehicle 302 is on the digital map(s). In particular, the mapping module 327 may receive perception data from perception and understanding module 303 or from the various sensors sensing the environment surrounding autonomous vehicle 302 and may correlate features of the sensed environment with details (e.g., digital representations of the features of the sensed environment) on the one or more digital maps. The digital map may have various levels of detail and can be, for example, a raster map, or a vector map. The digital maps may be stored locally on the autonomous vehicle 302 or stored and accessed remotely. In at least one embodiment, the autonomous vehicle 302 deploys with sufficient stored information in one or more digital map files to complete a mission without connection to an external network during the mission.

The behaviors and planning module 333 and the control module 335 plan and implement one or more behavior-based trajectories to operate the autonomous vehicle 302 similarly to a human driver-based operation. The behaviors and planning module 333 and control module 335 use inputs from the perception and understanding module 303 or mapping module 327 and motion estimation 329 to generate trajectories or other planned behaviors. For example, behavior and planning module 333 may generate potential trajectories or actions and select one or more of the trajectories to follow or enact by the controller 335 as the vehicle travels along the road. The trajectories may be generated based on proper (i.e., legal, customary, and safe) interaction with other static and dynamic objects in the environment. Behaviors and planning module 333 may generate local objectives (e.g., following rules or restrictions) such as, for example, lane changes, stopping at stop signs, etc. Additionally, behavior and planning module 333 may be communicatively coupled to, include, or otherwise interact with motion planners, which may generate paths or actions to achieve local objectives. Local objectives may include, for example, reaching a goal location while avoiding obstacle collisions.

Based on the data collected from the sensors 306, the autonomy computing system 304 is configured to perform calibration, analysis, and planning, and control the operation and performance of autonomous vehicle 302. For example, the autonomy computing system 304 is configured to estimate the motion of autonomous vehicle 302, calibrate parameters of the sensors, such as the extrinsic rotations of cameras, LIDAR, RADAR, and IMU, as well as intrinsic parameters, such as lens distortions, in real-time, and provide a map of surroundings of autonomous vehicle 302 or the travel routes of autonomous vehicle 302. The calibration module 323 of a particular embodiment may include instructions to interface external calibration equipment and software at hub. The autonomy computing system 304 is configured to analyze the behaviors of autonomous vehicle 302 and generate and adjust the trajectory plans for the autonomous vehicle 302 based on the behaviors computed by the behaviors and planning module 333.

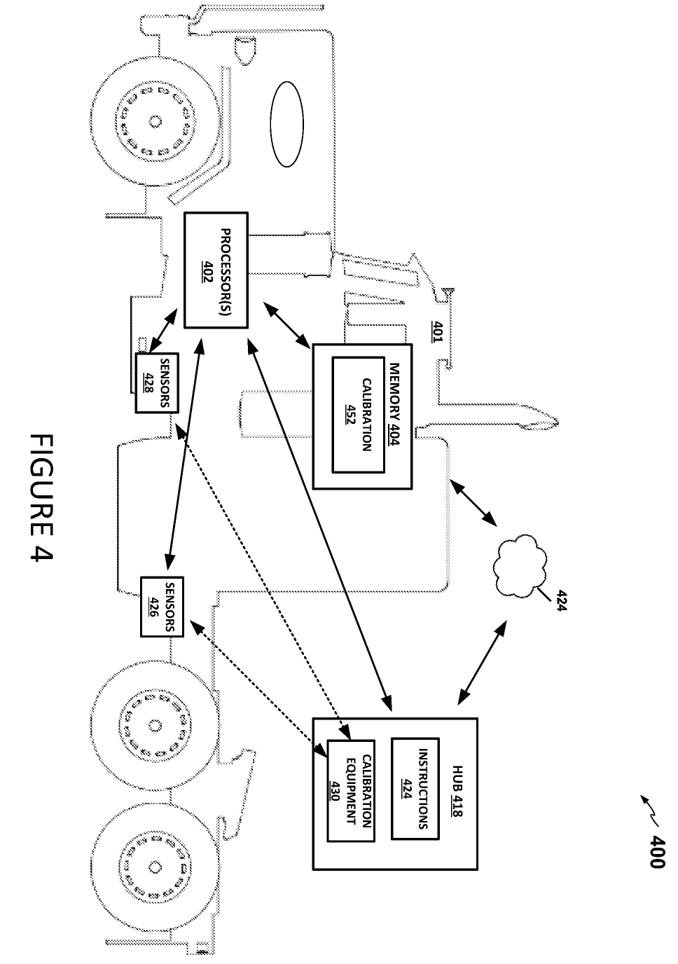

FIG. 4 is a block diagram showing illustrative components of hub calibration system 400 juxtaposed with an outline of a crewed, autonomous, or semi-autonomous vehicle 401. The relative positioning of the modules with respect to the outline are not intended to indicate a physical location, as the underlying hardware, software, and functionality of the modules may be dispersed throughout the vehicle and remotely throughout the system 400. For example, the system 400 includes one or more processors 402 in communication with a memory 404. While the processors 402 and memory 404 are depicted as being included within the autonomous truck, the processors and memory of another implementation, as well as their related functions may be distributed throughout one or more local and remote systems. For instance, a hub 418 may communicate instructions 424 and data via a wireless connection. In another example, the one or more processors may include circuitry present in one or more of the modules illustrated in FIG. 4 or at a mission control center (not shown).

A memory 404 includes calibration instructions 452 (i.e., modules, or algorithms) executable by the processors 402 to operate the autonomous vehicle 401 within the hub 418 and to calibrate sensors 426, 428 based on markers along a calibration path. To this end, the sensors 426 may be responsive to sensed calibration equipment 430. The processors 402 may receive the inputs from the sensors 426, 428 and may calibrate them according using instructions present at the hub 418 or the memory 404.

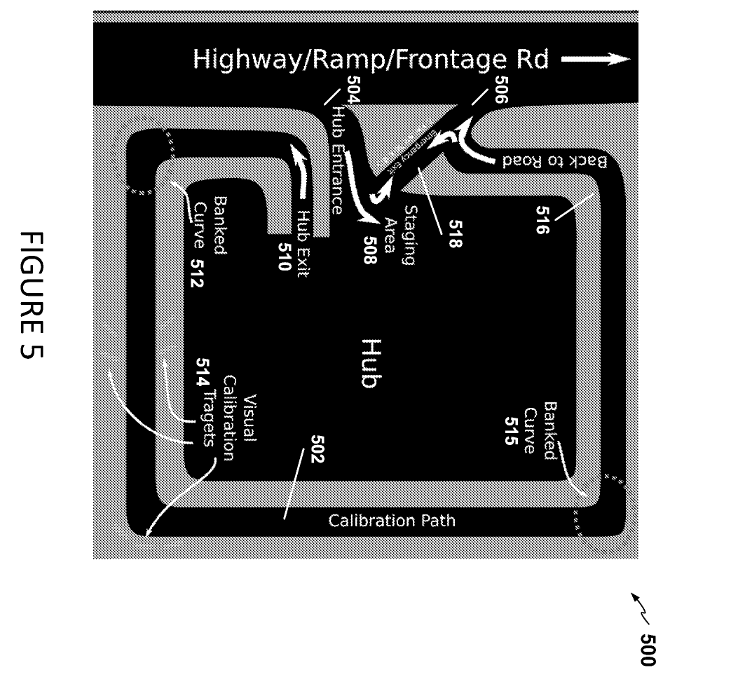

FIG. 5 is topographical diagram of an embodiment of an autonomous vehicle hub 500 that includes external sensor calibration equipment strategically positioned along a designated calibration path. The illustrative hub system 500 is designed incudes a designated calibration path and traffic pattern that enables automated calibration. The calibration path may minimize disruption to normal traffic and avoid decreasing hub throughput. The physical components and features using in the calibration may be strategically placed within the hub environment 500. Such components and features may include visual calibration targets, electronic signal exchanges, turns, inclines, and road curvatures, among others.

As labeled in the drawing, the hub system 500 includes a hub entrance from which vehicles may enter from the highway by making a righthand turn. The entrance and exit may be oriented such that trucks entering to not interfere with trucks exiting back onto the highway. The vehicle may enter a staging area where it awaits an indication to enter a calibration path via the path opening designated as the hub exit. Processors at the hub and/or at a mission control may function in a manner analogous to an air traffic control center to manage vehicle arrivals, exits, and calibration processes. For instance, the hub 500 may allow only one vehicle at a time to use the calibration path to avoid traffic jams.

At the staging area, an autonomous, or semi-autonomous vehicle of an implementation may be paired with and guided by a shepherd vehicle. The shepherd vehicle may logically or physically link with the vehicle to guide it partially or completely throughout the calibration path. Such a configuration may reduce memory requirements for vehicle by avoiding storage of the route in vehicle memory. In other cases, the vehicle may be able to autonomously drive itself the around the calibration route by accessing stored and/or downloaded driving instructions. Another or the same embodiment may include visual cues (e.g., machine readable codes) that are recognized by the vehicle and guide it throughout the hub.

Once traveling counterclockwise along the calibration path, the vehicle may initially include a first banked curve, as illustrated. As explained herein, the inclination of the bank is known and can be used to calibrate vehicle sensors.

The vehicle may encounter a sensory jungle comprising visual calibration targets that are used to calibrate cameras, LiDAR, and radar, among other visual based sensors. The vehicle may be directed to stop and resume driving at different points along the calibration path. For example, static IMU calibrations may be performed while the vehicle is stopped at the visual based sensors. Such calibrations may include acceleration leveling and gyroscope biasing.

Markers comprising calibration equipment may include targets that have stylized symbols (e.g., similar to a barcode) that can be placed accurately with a millimeter or less of precision. Know the ground truth, software the vehicle may determine an exact orientation of a camera and relative to other cameras or make sure that transceivers are able to effectively communicate with signals equipment from other markers.

The illustrative calibration path includes another banked curve that additionally orients the vehicle 180 degrees from its position at the first bank. Static portions of an IMU calibration may be performed at these banks along the calibration path, which may be marked with appropriate markers.

The exit from the hub 500 may include a lefthand turn along the calibration pathway before exiting to the right to the highway. The lefthand turn facilitates the counterclockwise flow within the hub 500,

In some implementations, the vehicle may receive an indication at some point that a calibration has not been successful. Onboard processors may not have been able to converge to certain precision, for instance. For such a scenario, the hub system 500 may include an emergency exit and failure re-entry lane that branches off from the calibration path. The lane may allow for travel from the calibration path to either the staging area or highway. A vehicle could also leave the staging area directly for the highway.

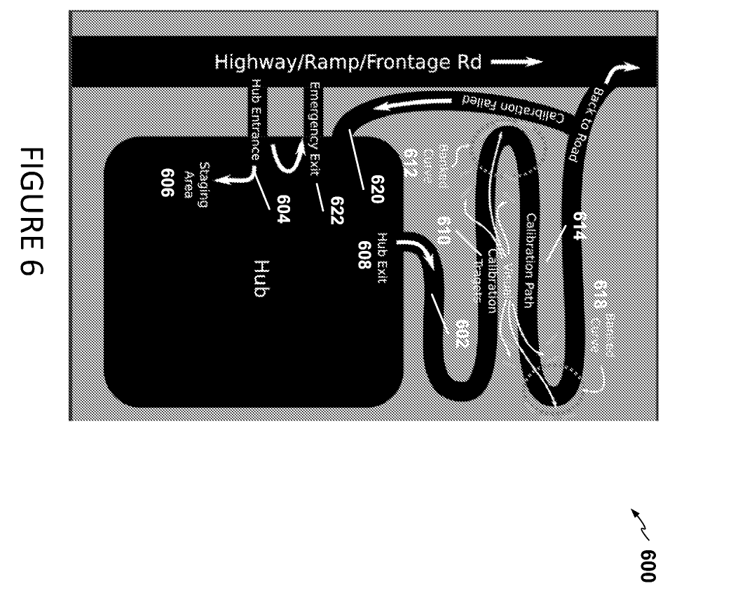

FIG. 6 is topographical diagram of another embodiment of an autonomous vehicle hub 600 that includes external sensor calibration equipment strategically positioned along a designated calibration path. As with the hub system 500 of FIG. 5, the illustrative hub system 600 is designed incudes a designated calibration path and traffic pattern that enables automated calibration. The hub system 600 includes a different layout of visual calibration targets, electronic signal exchanges, turns, inclines, and road curvatures, among other strategically placed calibration equipment and road features within the hub environment 600.

As labeled in the drawing, the hub system 600 includes a hub entrance from which vehicles may enter from the highway by making a righthand turn. The vehicle may enter a staging area where it awaits an indication to enter a calibration path via the ingress designated as the hub exit. As with the system 500 of FIG. 5, processors at the hub system 600 and/or at a mission control (not shown) may function may direct vehicle arrivals, exits, and calibration processes. For instance, the hub system 600 may allow only one vehicle at a time to use the calibration path to avoid traffic issues.

At the staging area, an autonomous, or semi-autonomous vehicle of an implementation may be paired with and guided by a shepherd vehicle. In other cases, the vehicle may be able to autonomously drive itself the around the calibration route by accessing stored and/or downloaded driving instructions. Another or the same embodiment may include visual markers that are recognized by the vehicle and guide it throughout the hub.

Once traveling counterclockwise along the calibration path, the vehicle may initially encounter visual calibration targets. The vehicle may be instructed to stop or move in a directed fashion during visual calibration. The vehicle may then arrive at a first banked curve, as illustrated. As explained herein, the inclination of the bank is known and can be used to calibrate vehicle sensors.

The vehicle may travel one to encounter a second sensory jungle. An example of such a system may include visual calibration targets that are used to calibrate cameras, LiDAR, and radar, among other visual based sensors. A sensory jungle of another implementation may include equipment for calibrating non-visual based sensors.

The illustrative calibration path includes a second banked curve that additionally orients the vehicle 180 degrees from its position at the first bank. The vehicle may be directed to stop and resume driving at different points along the calibration path, as functionally desired. As illustrated, the second banked curve may additionally function orient the vehicle in a position to exit right to the highway. The lefthand turn of the second banked curve facilitates the counterclockwise flow within the hub 600.

In some implementations within the hub system 600, the vehicle may receive an indication at some point that a calibration was unsuccessful. For such a scenario, the hub system 500 may include a calibration failed lane that branches off from the calibration path before the highway. The lane may allow for travel from the calibration path to the staging area. An emergency exit lane may additionally be included to allow a vehicle to leave the staging area directly for the highway.

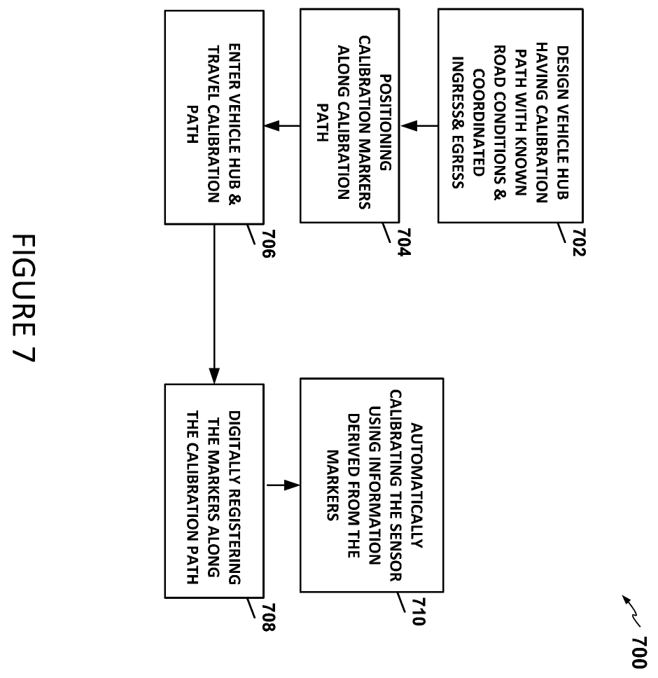

FIG. 7 is a flow diagram of an embodiment of a method of calibrating a sensor of a vehicle while traveling along a calibration path of a vehicle hub. While many of the illustrative processes described herein may apply to a semi-truck and trailer, the embodiments of the underlying method 700 may apply to other types of autonomously driven vehicles. Moreover, the processes presented in the flow diagram may be performed in different sequences in different embodiments of the method 700, which may omit or add other processes from that which is shown in the example of FIG. 7. The method 700 may be at least partially performed by any of the systems described in FIGS. 1-4.

Turning more particularly to FIG. 7, the method 700 includes designing a vehicle hub at 702 that includes a calibration path with known road conditions and a coordinated ingress and egress pattern. For instance, the design may include designed banked curves, turns, and distance. The entrance and exit to the vehicle hub may be oriented to facilitate an ordered flow of traffic, such as the uniformly counterclockwise directional traffic of the vehicle hub 500 of FIG. 5.

At 704, the method 700 may include positioning calibration markers, along the calibration path. For example, a target jungle may be used to align optical sensors, such as cameras, LiDAR, and radar, among others, to each other.

The vehicle may enter the hub at 706 and travel the calibration path. While traversing the calibration path, the vehicle may digitally register (e.g., via sensors) the markers that have been positioned along the calibration path. At 710, the processing system of the vehicle may automatically calibrate the sensors using information derived from the calibration markers

Some embodiments involve the use of one or more electronic processing or computing devices. As used herein, the terms “processor” and “computer” and related terms, e.g., “processing device,” “processing system,” and “controller” are not limited to just those integrated circuits referred to in the art as a computer, but broadly refers to a processors, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms such as processor, processing device, and related terms.

In the embodiments described herein, memory may include, but is not limited to, a non-transitory computer-readable medium, such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A vehicle hub comprising:
an entry from a roadway;
an exit;
a calibration path connecting the entry to the exit; and
a calibration marker positioned along the calibration path, wherein the calibration marker corresponds to at least one of a known road condition or calibration equipment, and wherein the at least one known position or calibration equipment is used to automatically calibrate an onboard sensor of an autonomous or semi-autonomous vehicle traveling along the calibration path.

2. The vehicle hub of claim 1, further comprising: a memory storing instructions, and at least one processor configured to access the memory and execute the instructions to monitor travel of the autonomous or semi-autonomous vehicle inside of the vehicle hub.

3. The vehicle hub of claim 1, wherein the known road condition includes at least one of: a grade, a curve, and a slope of a banked curve, an incline, and a turn.

4. The vehicle hub of claim 1, wherein the calibration equipment includes at least one of a stylized symbol, a bar code, and an electronic signal.

5. The vehicle hub of claim 1, wherein the exit is an exit back to the roadway.

6. The vehicle hub of claim 5, wherein the calibration path includes a lefthand turn to reach the exit.

7. The vehicle hub of claim 1, wherein the automatic calibration is performed by at least one processor onboard the autonomous or semi-autonomous vehicle.

8. The vehicle of claim 1, wherein the autonomous or semi-autonomous vehicle drives autonomously along the calibration path using directional cues that visually or electronically instruct movement of the autonomous or semi-autonomous vehicle.

9. The vehicle of claim 1, wherein the autonomous or semi-autonomous vehicle drives autonomously along the calibration path using downloaded instructions executed to navigate the vehicle hub.

10. The vehicle of claim 1, wherein the autonomous or semi-autonomous vehicle is guided along the calibration path by a shepherd vehicle.

11. A vehicle comprising:
a sensor;
a memory storing instructions;
at least one processor configured to:
receive signals from the sensor;
access the memory; and
execute the instructions to:
travel along a calibration path of a vehicle hub, wherein a calibration marker is positioned along the calibration path, and wherein the calibration marker corresponds to at least one of a known road condition or positioned calibration equipment; and
automatically calibrate the sensor using at least one of the known road condition or calibration equipment.

12. The vehicle of claim 11, wherein traveling along the calibration path further includes the at least one processor autonomously driving the vehicle along the calibration path.

13. The vehicle hub of claim 11, wherein the known road condition includes at least one of: a grade, a curve, and a slope of a banked curve, an incline, and a turn.

14. The vehicle hub of claim 11, wherein the calibration equipment includes at least one of a stylized symbol, a bar code, and an electronic signal.

15. The vehicle of claim 11, wherein the at least one processor is further configured to receive directional cues that visually or electronically instruct movement of the vehicle.

16. The vehicle of claim 11, wherein the at least one processor is further configured to execute downloaded instructions to navigate the hub.

17. A method of calibrating a sensor of a vehicle, the method comprising:
traveling along a calibration path of a vehicle hub, wherein a calibration marker is positioned along the calibration path, and wherein the calibration marker corresponds to at least one of a known road condition or positioned calibration equipment;
digitally registering the calibration marker while traveling along the calibration path; and
automatically calibrating the sensor using at least one of the known road condition or calibration equipment.

18. The method of claim 17, further comprising receiving directional cues that visually or electronically instruct movement of the vehicle.

19. The method of claim 17, further comprising executing downloaded instructions to navigate the hub.

20. The method of claim 17, further comprising executing a lefthand turn to reach an exit of the vehicle hub.
